(19) United States
(12) Patent Application Publication
(10) Pub. No.: US 2024/0375416 A1
(43) Pub. Date: Nov. 14, 2024

(54) IMAGE FORMING APPARATUS

(71) Applicant: CANON KABUSHIKI KAISHA, Tokyo (JP)

(72) Inventor: SHUNICHI KOGA, Chiba (JP)

(21) Appl. No.: 18/651,872

(22) Filed: May 1, 2024

(30) Foreign Application Priority Data
May 9, 2023 (JP) 2023-077469

(51) Int. Cl. B41J 11/20; B41J 11/00; B41J 13/08; B65H 5/22

(52) U.S. Cl. CPC B41J 11/20; B41J 11/0085; B41J 13/08; B65H 5/224; B65H 2403/51; B65H 2404/25; B65H 2406/3124; B65H 2557/64

(57) ABSTRACT

An image forming apparatus includes a belt configured to convey a sheet, a plurality of rollers over which the belt is stretched, the plurality of rollers including a drive roller to which a drive force is to be applied, a support portion configured to support at least one of the plurality of rollers in a manner that allows the at least one of the plurality of rollers to rotate, an ejection portion configured to eject ink onto the sheet conveyed by the belt, a movable member placed in a movable manner on an inner circumferential surface side of the belt in order to adjust a distance between the ejection portion and an outer circumferential surface of the belt at a position opposed to the ejection portion, a cam configured to displace a position of the movable member.

### BACKGROUND OF THE INVENTION

### Field of the Invention

The present disclosure relates to an image forming apparatus for forming an image on a sheet by an inkjet method.

### Description of the Related Art

There has been known an inkjet image forming apparatus that forms an image by ejecting ink droplets on a sheet being conveyed (Japanese Patent Application Laid-open No. 2016-196147).

In the inkjet image forming apparatus, as a gap (print gap) between a nozzle surface of a recording head from which ink is ejected and a surface of a sheet on which an image is to be formed (an image printing surface) increases, it takes longer for the ink ejected from the nozzle surface to reach the sheet. That is, with a configuration that forms an image on a sheet being conveyed, a position at which an image is formed on the sheet in a case where the print gap has a first magnitude differs from a position at which an image is formed on the sheet in a case where the print gap has a second magnitude greater than the first magnitude. Specifically, in a conveying direction in which the sheet is conveyed, the position at which an image is formed on the sheet in a case where the print gap has the second magnitude is on an upstream side of the position at which an image is formed on the sheet in a case where the print gap has the first magnitude.

In Japanese Patent Application Laid-open No. 2016-196147, there is disclosed a configuration in which a whole sheet conveying unit including conveying rollers is moved up and down to suit a thickness of a sheet being conveyed so that the print gap is adjustable. The sheet conveying unit is large in size, and a motor used to move the sheet conveying unit up and down is accordingly required to be high power. This leads to an increase in overall size of the image forming apparatus.

In addition, in a case of forming an image by ejecting ink onto a sheet, a conveying direction of a conveying surface in relation to the recording head is required to be positioned with precision in order to raise precision of a position at which the image is formed in relation to the sheet.

With the configuration as disclosed in Japanese Patent Application Laid-open No. 2016-196147, it is difficult to adjust the print gap with high precision because the sheet conveying unit itself is large in size. For this reason, there is a fear that, in a case where the sheet conveying unit is moved up and down, the conveying surface may be misaligned in relation to the recording head, and a position at which the image is formed in relation to the sheet may be misaligned. In view of the problems described above, an object of the present disclosure is to provide an image forming apparatus capable of adjusting a distance between a nozzle surface and a sheet with misalignment of a conveying surface in relation to a recording head reduced.

### SUMMARY OF THE INVENTION

An image forming apparatus according to at least one embodiment of the present disclosure includes a belt configured to convey a sheet, a plurality of rollers over which the belt is stretched, the plurality of rollers including a drive roller to which a drive force is to be applied, a support portion configured to support at least one of the plurality of rollers in a manner that allows the at least one of the plurality of rollers to rotate, an ejection portion configured to eject ink onto the sheet conveyed by the belt, a movable member placed in a movable manner on an inner circumferential surface side of the belt in order to adjust a distance between the ejection portion and an outer circumferential surface of the belt at a position opposed to the ejection portion, a cam configured to displace a position of the movable member in relation to the plurality of rollers, and a control portion configured to rotate, in order to adjust the distance, the cam by an amount depending on a basis weight of the sheet.

Further features of the present invention will become apparent from the following description of exemplary embodiments (with reference to the attached drawings).

### BRIEF DESCRIPTION OF THE DRAWINGS

FIG. 1 is a configuration diagram of an image forming system.

FIG. 2 is a configuration diagram of a print belt unit.

FIG. 3 is a perspective view of a pressure chamber and negative pressure generation units.

FIG. 4 is a schematic view around the pressure chamber.

FIG. 5 is an explanatory view of a fixed state of a recording head.

FIG. 6 is a perspective view of the pressure chamber as viewed from a negative pressure generation unit side.

FIG. 7A and FIG. 7B are explanatory diagrams of a change in position of the pressure chamber caused by rotation of cams.

FIG. 8 is a configuration view of a print belt unit frame.

FIG. 9 is an explanatory view of a print gap adjustment mechanism.

FIG. 10 is a configuration diagram of a controller.

FIG. 11 is an exemplary table of information on rotation phases.

FIG. 12 is a flow chart for illustrating print gap adjustment processing.

### DESCRIPTION OF THE EMBODIMENTS

Now, referring to the accompanying drawings, a description is given of at least one exemplary embodiment of the present disclosure.

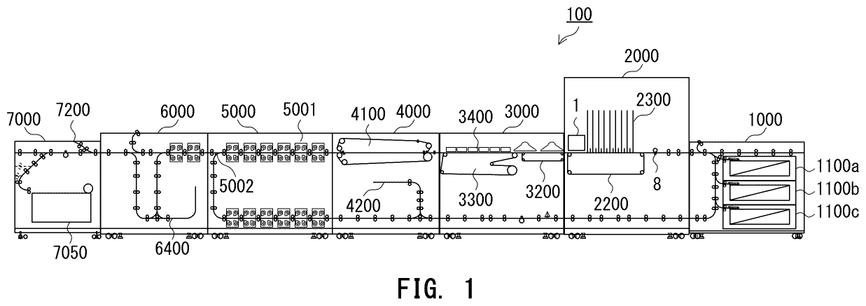

FIG. 1 is a configuration diagram of an image forming system in the at least one embodiment. An image forming system 100 is, for example, a printing machine to be used in a commercial and industrial printing field. The image forming system 100 in the at least one embodiment is a sheet-fed inkjet recording apparatus which generates a printed product by forming an ink image on a sheet with use of two liquids which are a reaction liquid and ink. The image forming system 100 includes a sheet feeding module 1000, a print module 2000, a drying module 3000, a fixing module 4000, a cooling module 5000, a reversing module 6000, and a delivery stacking module 7000. A cut sheet (hereinafter simply referred to as “sheet”) on which an image is to be printed is fed from the sheet feeding module 1000, receives predetermined processing at each module, and is delivered to the delivery stacking module 7000.

The sheet feeding module 1000 includes a plurality of (in the at least one embodiment, three tiers of) sheet storage portions 1100a to 1100c. The sheet storage portions 1100a to 1100c can each store sheets. The sheet storage portions 1100a to 1100c are configured so that each sheet storage portion can be pulled out to a front side of the apparatus. The sheet storage portions 1100a to 1100c are pulled out to the front side of the apparatus to receive sheets. The sheet feeding module 1000 feeds sheets one by one to the print module 2000. Accordingly, the sheet storage portions 1100a to 1100c are each provided with a separation belt and a conveying roller. The number of the sheet storage portions 1100a to 1100c is an example, and a single tier of sheet storage portion, or two, or four or more, tiers of sheet storage portions may be provided.

The print module 2000 is an inkjet image forming apparatus, and forms an image on the sheet fed from the sheet feeding module 1000. The print module 2000 includes a pre-image-forming registration correction portion 8, a print belt unit 2200, and a recording portion 2300. The pre-image-forming registration correction portion 8 corrects a tilt and a position of the sheet fed from the sheet feeding module 1000, and conveys the corrected sheet to the print belt unit 2200.

The print belt unit 2200 and the recording portion 2300 are arranged so as to face each other across a conveying path of the sheet, on a downstream side of the pre-image-forming registration correction portion 8 in a conveying direction of the sheet. The print belt unit 2200 conveys, by suction, the sheet conveyed from the pre-image-forming registration correction portion 8. The recording portion 2300 is a sheet processing portion for forming an image on the sheet conveyed from the print belt unit 2200 by performing, from above the sheet, recording processing (printing) with a recording head. The recording head executes printing by ejecting ink onto the sheet. A clearance between the recording head and the sheet is kept constant through conveyance of the sheet by way of suction by the print belt unit 2200.

A plurality of recording heads are arranged side by side along the conveying direction of the sheet. The recording head in the at least one embodiment is a line-type recording head having five recording heads which correspond to a reaction liquid in addition to four colors: yellow (Y), magenta (M), cyan (C), and black (K). The number of colors and the number of recording heads are not limited to five. Examples of an adoptable inkjet method include a method that uses a heating element, a method that uses a piezo element, a method that uses an electrostatic element, and a method that uses a MEMS element. Ink of each color is supplied to the corresponding recording head via an ink tube from an ink tank (not shown).

The sheet on which printing has been executed by the recording portion 2300 is conveyed by the print belt unit 2200. An image reading apparatus 1 which is an in-line scanner is placed on a downstream side of the recording portion 2300 in the conveying direction. The image reading apparatus 1 is used to correct a printed image by detecting misalignment and color concentrations of the image formed on the sheet.

The drying module 3000 dries the sheet on which the image has been formed by the print module 2000. The drying module 3000 reduces a liquid constituent contained in the ink by drying the sheet, to thereby improve fixability of the ink to the sheet. The drying module 3000 includes a decoupling portion 3200, a drying belt unit 3300, and a hot air blowing portion 3400.

The sheet on which printing has been executed by the recording portion 2300 of the print module 2000 is conveyed to the decoupling portion 3200 inside the drying module 3000. The decoupling portion 3200 conveys the sheet by lightly holding the sheet with use of a wind pressure from above and friction from a belt. This prevents misalignment of a part of the sheet that remains on the print belt unit 2200 in a case where the sheet lays partially on the decoupling portion 3200 and the rest of the sheet is on the print belt unit 2200.

The sheet conveyed from the decoupling portion 3200 is conveyed by suction by the drying belt unit 3300, and hot air is concurrently blown onto the sheet from the hot air blowing portion 3400 placed above the belt, to thereby dry an ink applied surface (image printed surface). As the drying method, the method of blowing hot air may be combined with a method of irradiating a sheet surface with an electromagnetic wave (an ultraviolet ray, an infrared ray, or the like), a conductive heat transfer method by contact with a heat generator, or other methods.

The fixing module 4000 fixes the image to the sheet by heating the sheet that has been dried by the drying module 3000, and thus drying the ink. The fixing module 4000 includes a fixing belt unit 4100 which includes an upper belt unit and a lower belt unit. The fixing module 4000 passes the sheet that has been conveyed from the drying module 3000 between the upper belt unit and the lower belt unit which have each been heated, to thereby fix the ink to the sheet.

The cooling module 5000 cools the sheet to which the image has been fixed by the fixing module 4000, to thereby solidify the ink softened from heating, and, at the same time, suppress a temperature change caused in the sheet by a downstream apparatus. The cooling module 5000 includes a plurality of cooling portions 5001. The plurality of cooling portions 5001 cool the high-temperature sheet conveyed from the fixing module 4000. The cooling portions 5001 are each configured so as to raise a pressure in a cooling box by taking outside air into the cooling box with use of a fan, blow a wind out of a nozzle formed in a conveying guide onto the sheet, and thus cool the sheet. The plurality of cooling portions 5001 are arranged on each side of the conveying path so that the sheet can be cooled from both sides.

A conveying path switching portion 5002 is provided in the cooling module 5000. The conveying path switching portion 5002 switches the conveying path of the sheet between a path on which the sheet is to be conveyed to the reversing module 6000 and a duplex-printing conveying path to be used in duplex printing.

In duplex printing, the sheet is conveyed from the conveying path in a lower part of the cooling module 5000 to the duplex-printing conveying path of the fixing module 4000, the drying module 3000, the print module 2000, and the sheet feeding module 1000. A duplex-printing portion of the fixing module 4000 is provided with a first reversing portion 4200 for reversing a front surface and a back surface of the sheet. The sheet is conveyed to the first reversing portion 4200 once, and then reversed and conveyed to the drying module 3000 side, and the image printing surface is thus reversed. The stop at the first reversing portion 4200 enables printing on the back surface of the sheet. After that, the sheet is again conveyed to the pre-image-forming registration correction portion 8, the print belt unit 2200, and the recording portion 2300 of the print module 2000 to be printed on.

The reversing module 6000 includes a second reversing portion 6400. The reversing module 6000 uses the second reversing portion 6400 to reverse the front surface and the back surface of the sheet being conveyed. Directions in which the front surface and the back surface of the sheet that is about to be delivered can thus be changed. The delivery stacking module 7000 includes a top tray 7200 and a stacking portion 7500. The delivery stacking module 7000 stacks, in an orderly manner, sheets conveyed from the reversing module 6000.

### <Print Belt Unit>

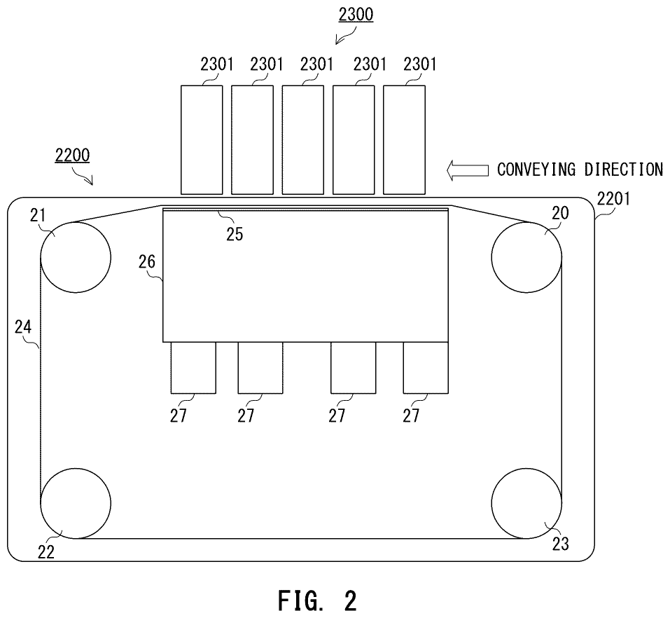

FIG. 2 is a configuration diagram of the print belt unit 2200. The print belt unit 2200 includes a plurality of (in the at least one embodiment, four) suspension rollers 20 to 23 supported by a print belt unit frame 2201, and an endless conveyor belt 24 stretched over the suspension rollers 20 to 23. The print belt unit frame 2201 is configured so as to nip both ends of the suspension rollers 20 to 23 from a near side and a far side of FIG. 2. Details of the print belt unit frame 2201 are described later.

At least one of the suspension rollers 20 to 23 functions as a driving roller to turn the conveyor belt 24. With the turn of the conveyor belt 24, the sheet is conveyed in the conveying direction. At least one of the suspension rollers 20 to 23 excluding the driving roller functions as a tension roller to apply a predetermined degree of tension to the conveyor belt 24. Application of the predetermined degree of tension enables the conveyor belt 24 to turn without sagging.

The sheet is stuck by suction to a belt surface of the conveyor belt 24 that is stretched over the suspension roller 20 and the suspension roller 21. A plurality of suction holes for suctioning the sheet are formed in the conveyor belt 24. The sticking of the sheet to the conveyor belt 24 by suction stabilizes behavior of the sheet being conveyed.

In the recording portion 2300, the plurality of recording heads described above are denoted by 2301 and are provided side by side in the conveying direction of the sheet (a turning direction of the conveyor belt 24). The recording heads 2301 eject ink onto the sheet to form an image on the sheet. Stabilization of the behavior of the sheet being conveyed enables the recording heads 2301 to steadily print on the printing surface of the sheet.

The print belt unit 2200 has, at a position opposite from the recording portion 2300 across the belt surface of the conveyor belt 24 on which the sheet is conveyed, a pressure chamber 26 including a platen 25 in which a plurality of holes are formed. The platen 25 forms a sheet conveying surface and is arranged opposite from the recording portion 2300. A plurality of negative pressure generation units 27 for generating a negative pressure inside the pressure chamber 26 are connected to the pressure chamber 26. The pressure chamber 26 and the plurality of negative pressure generation units 27 are mounted inside the print belt unit frame 2201 in a detachable manner.

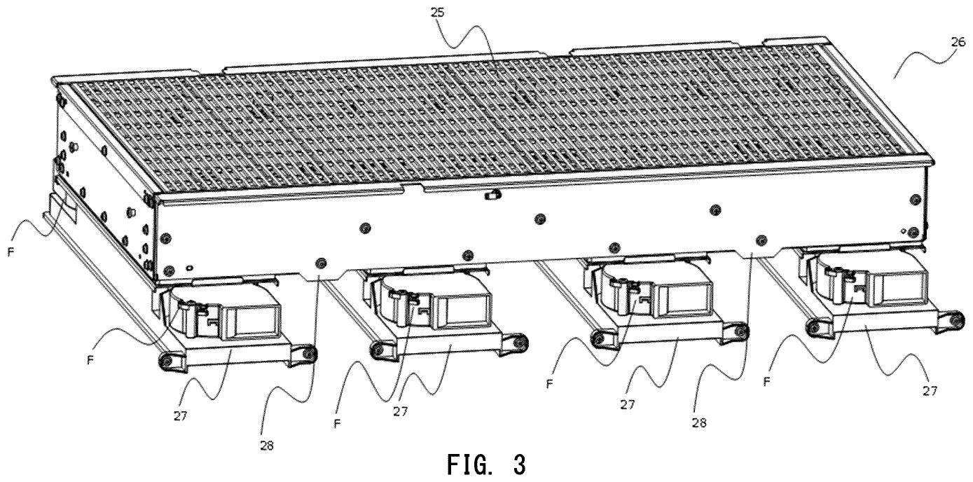

FIG. 3 is a perspective view of the pressure chamber 26 and the negative pressure generation units 27. The pressure chamber 26 is provided with a plurality of pressurizing portions 28 on a side on which the plurality of negative pressure generation units 27 are provided. The plurality of negative pressure generation units 27 each include a fan F. The fan F exhausts air inside a corresponding one of the negative pressure generation units 27. This generates a negative pressure inside the corresponding one of the negative pressure generation units 27.

Insides of the plurality of negative pressure generation units 27 communicate with an inside of the pressure chamber 26. Accordingly, pressures inside the plurality of negative pressure generation units 27 turning negative causes a pressure inside the pressure chamber 26 to become negative as well. The negative pressure inside the pressure chamber 26 generates, via the holes of the platen 25 formed in the pressure chamber 26, a suction force in the suction holes formed in the conveyor belt 24. The suction force generated in the suction holes of the conveyor belt 24 sticks the sheet to the conveyor belt 24 by suction.

The pressurizing portions 28 are protrusions formed in four corners on a side of the pressure chamber 26 on which the negative pressure generation units 27 are provided. The pressurizing portions 28 are used to close or increase a distance of the pressure chamber 26 from the recording portion 2300.

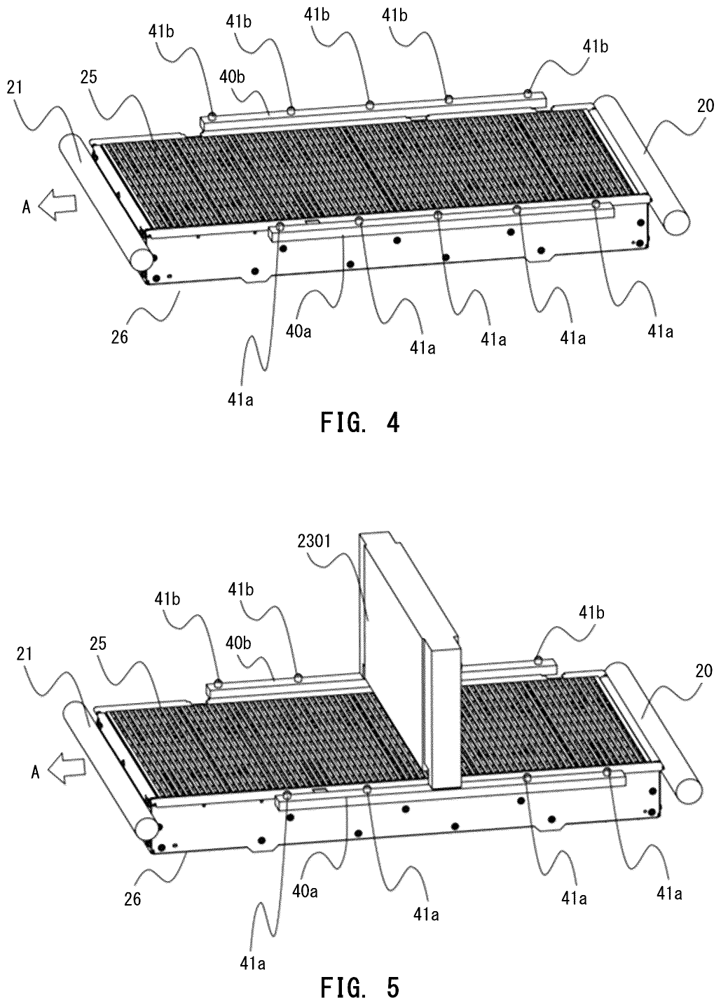

FIG. 4 is a schematic view around the pressure chamber 26. Two recording portion holding members 40a and 40b are fixed to the print belt unit frame 2201 for supporting the suspension rollers 20 to 23, in a direction intersecting a conveying direction A of the sheet, so as to face each other across the pressure chamber 26. Head fixing portions 41a and 41b are provided at each of positions corresponding to the plurality of recording heads 2301. In the at least one embodiment, five head fixing portions 41a and five head fixing portions 41b which correspond to five recording heads 2301 are provided for the two recording portion holding members 40a and 40b, with the five head fixing portions 41a provided in the recording portion holding member 40a and the five head fixing portions 41b provided in the recording portion holding member 40b.

FIG. 5 is an explanatory view of a fixed state of the recording heads 2301. Here, the fixed state of one of the recording heads 2301 is described. The recording head 2301 is fixed to the print belt unit frame 2201. The recording head 2301 is fixed so as to butt against its corresponding head fixing portions 41a and 41b. The recording head 2301 is positioned by its corresponding head fixing portions 41a and 41b. The recording head 2301 is biased in directions of the recording portion holding members 40a and 40b by a pressurizing mechanism (not shown) provided in a main body of the print module 2000 or in the recording head 2301, to be fixed in an unmovable manner.

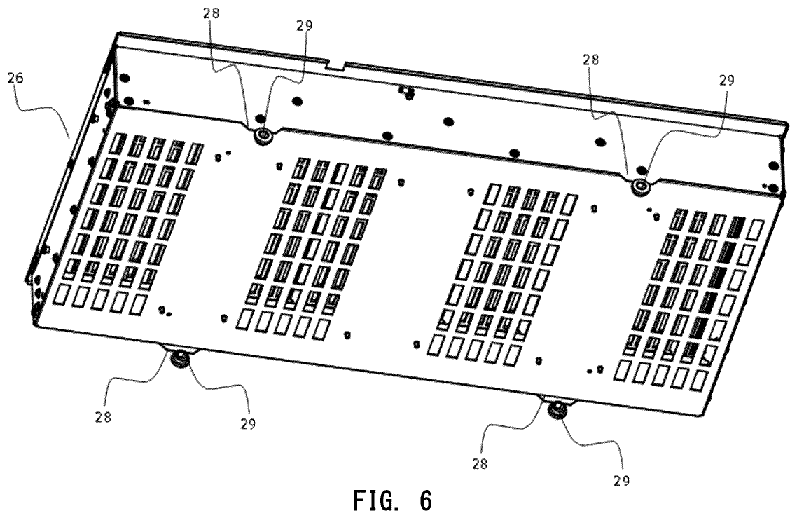

FIG. 6 is a perspective view of the pressure chamber 26 as viewed from the negative pressure generation units 27 side. In the print module 2000 in the at least one embodiment, the position of the recording portion 2300 including the recording heads 2301 is fixed by unmoving parts other than the pressure chamber 26, and the position of the pressure chamber 26 is variable. That is, the pressure chamber 26 is movable relative to the recording portion 2300 fixed in position.

With this configuration, a distance of the platen 25 from the recording portion 2300 can be closed or increased by moving the pressure chamber 26 in a manner depending on a thickness of the sheet. Accordingly, a distance (print gap) between the printing surface of the sheet stuck by suction to a part of the conveyor belt 24 that has the platen 25 and a nozzle surface (a surface from which ink is to be ejected) of each of the recording heads 2301 of the recording portion 2300 is adjustable to be constant irrespective of the type of the sheet.

As described above, the recording heads 2301 are fixed to the print belt unit frame 2201. The print gap is accordingly adjusted by moving the pressure chamber 26 in relation to the recording heads 2301. A surface area of ink that adheres to the sheet is constant because, in each of the recording heads 2301, the distance between the nozzle surface from which ink is ejected and the printing surface of the sheet is kept constant. Images printed on sheets accordingly have a constant size per dot. That is, a phenomenon in which a resolution of an image output by the image forming apparatus varies depending on the type of the sheet used can be reduced.

As illustrated in FIG. 6, cams 29 are used in the at least one embodiment as a moving adjustment mechanism for moving the pressure chamber 26 so that the distance of the pressure chamber 26 from the recording portion 2300 is closed or increased. Four cams 29 are provided so as to abut against the pressuring portions 28 provided in the four corners of the pressure chamber 26. The cams 29 function as a driver member and the pressurizing portions 28 (the pressure chamber 26) function as a follower member. Rotation of the cams 29 moves the pressure chamber 26 so that the pressure chamber 26 is close to or distanced from the recording portion 2300. Consequently, a distance of the part of the conveyor belt 24 that is above the platen 25 from the recording portion 2300 is closed or increased, to thereby execute a print gap adjustment in which the print gap is adjusted to be constant. The cams 29 may have any configuration, and eccentric cams are used in the at least one embodiment.

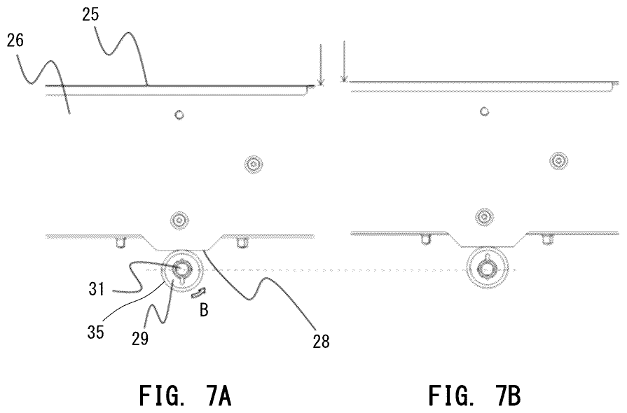

FIG. 7A and FIG. 7B are explanatory diagrams of a change in position of the pressure chamber 26 caused by rotation of the cams 29. In FIG. 7A, a state in which the pressure chamber 26 is most distanced from recording heads 2301 is illustrated. In FIG. 7B, a state in which the pressure chamber 26 is at the closest distance to the recording heads 2301 is illustrated. The cams 29 each rotate about a drive axis 31. A center of each of the cams 29 and a rotation center of its corresponding drive axis 31 are offset from each other by a predetermined offset amount. The cams 29 are each press-fit into a bearing 35. A rotation center of each of the cams 29 (the rotation center of the drive axis 31) and a center of the bearing 35 are offset from each other by the same amount as the offset amount of the center of each of the cams 29 and the rotation center of the drive axis 31. With this configuration, the rotation of the drive axis 31 causes the corresponding one of the cams 29 to rotate, to thereby move the bearing in a direction in which the pressurizing portions 28 are pushed up, or a direction in which the pressurizing portions 28 are pushed down. The pressure chamber 26 thus moves in relation to the recording heads 2301.

In the at least one embodiment, a shape of the cams 29 is set so that rotation of the cams 29 by 180 degrees causes a shift from the state in which the pressure chamber 26 is most distanced from the recording heads 2301 (FIG. 7A) to the state in which the pressure chamber 26 is at the closest distance to the recording heads 2301 (FIG. 7B). A displacement amount of the position of the pressure chamber 26 and relationship between a rotation angle and the position of the pressure chamber 26 can be set freely by the shape of the cams 29. An amount by which the pressure chamber 26 can be moved is adjusted by the amount of the offset between a rotation center of each of the cams 29 (the rotation center of the drive axis 31) and the center of the bearing 35. That is, the displacement amount of the pressure chamber 26 from the state of FIG. 7A to the state of FIG. 7B is determined by the amount of the offset between the rotation center of each of the cams 29 (the rotation center of the drive axis 31) and the center of the bearing 35.

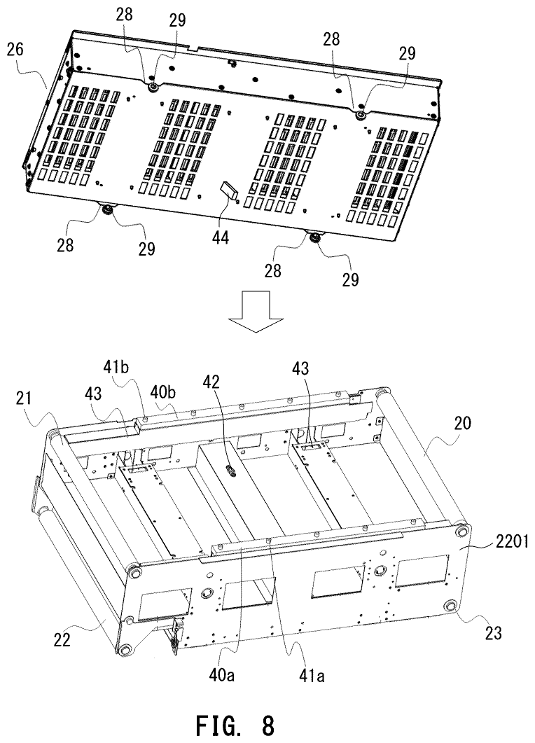

FIG. 8 is a configuration view of the print belt unit frame 2201. A first opening portion 42 and second opening portions 43 are formed in the print belt unit frame 2201, to be used for positioning in a case where the pressure chamber 26 is mounted inside the print belt unit frame 2201. Four second opening portion 43 corresponding to the four pressurizing portions 28 are provided so that the pressurizing portions 28 are inserted into the second opening portions 43. The cams 29 are provided below the second opening portions 43 in FIG. 8 so that the cams 29 are in contact with the pressurizing portions 28 inserted into the second opening portions 43.

On the side of the pressure chamber 26 on which the negative pressure generation units 27 are provided, a protrusion 44 is provided. The protrusion 44 is inserted into the first opening portion 42. The protrusion 44 inserted into the first opening portion 42 serves as a guide member and a positioning member in a case where the pressure chamber 26 is moved. In assembly of the print belt unit 2200, the protrusion 44 is inserted into the first opening portion 42, and the pressurizing portions 28 are inserted into the second opening portions 43. The pressure chamber 26 is thus attached at a predetermined position of the print belt unit frame 2201.

In a case where rotation of the cams 29 moves the pressure chamber 26, the pressure chamber 26 moves in a direction of the protrusion 44 inserted into the first opening portion 42. Accordingly, rotation of the cams 29 closes or increases the distance between the printing surface of the sheet and the recording heads 2301, but does not cause misalignment of a printing position. That is, the direction of movement of the pressure chamber 26 is limited only to a direction headed to (or moving away from) the recording portion 2300. In addition, the print belt unit frame 2201 is fixed in position, and hence does not follow movement of the pressure chamber 26.

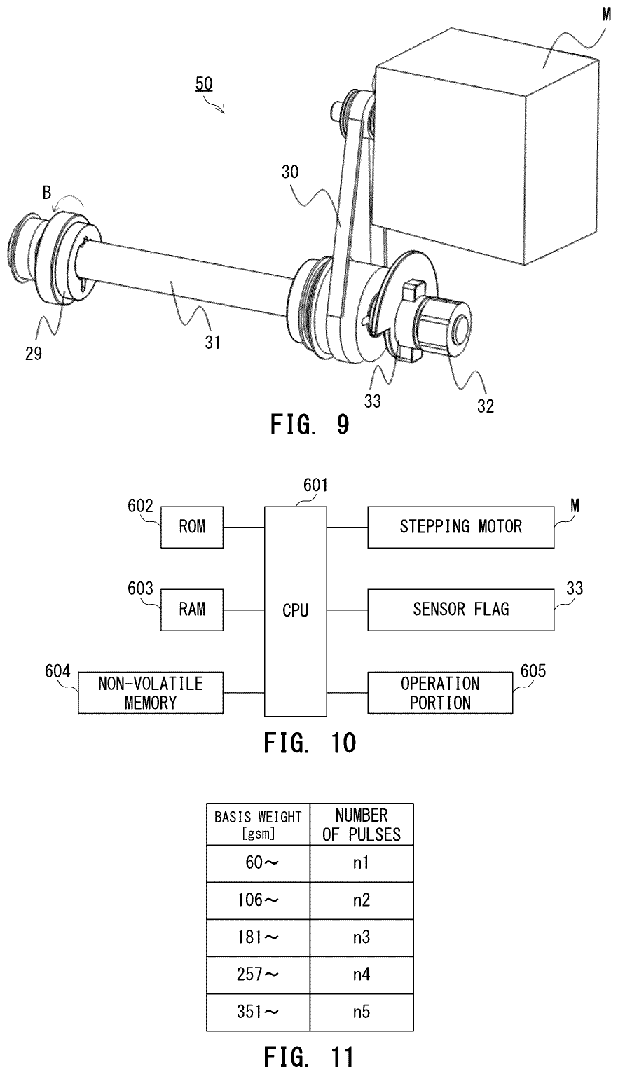

FIG. 9 is an explanatory view of a print gap adjustment mechanism.

The four cams 29 are individually controlled in rotation by print gap adjustment mechanisms 50 identical with one another. In FIG. 9, one of the print gap adjustment mechanisms 50 for one of the cams 29 is described.

The print gap adjustment mechanism 50 includes a stepping motor M, a drive belt 30, the drive axis 31, a one-way clutch 32, and a sensor flag 33. The stepping motor M is a drive source that outputs a drive force for rotating the cam 29. The stepping motor M causes the drive belt 30 to turn. The drive belt 30 rotates the drive axis 31. As described above, the drive axis 31 is attached to the cam 29, and turns to rotate the cam 29. In this manner, the drive force of the stepping motor M is transmitted to the cam 29 via the drive belt 30 and the drive axis 31.

A rotation direction of the stepping motor M is variable. A change in rotation direction of the stepping motor M sometimes causes a rotation angle of the cam 29 and a height of the highest point to be offset from each other due to a shift in an axial direction resulting from dimension tolerances of respective parts. For this reason, the rotation direction of the cam 29 is limited to one direction (in the at least one embodiment, a direction B).

The cam 29 receives a force from a corresponding one of the pressurizing portions 28, due to the own weight of the pressure chamber 26 and a tensile force of the stretched conveyor belt 24. Due to the force from the pressurizing portion 28, the cam 29 may receive a force (reverse rotation force) in a direction opposite to the direction B, depending on a rotation phase. The one-way clutch 32 is provided on the drive axis 31 in order to restrict the rotation of the cam 29 to one direction and thereby prevent a position fluctuation of the pressure chamber 26 that is caused by rotation of the cam 29 under the reverse rotation force in the reverse direction during printing. The provision of the one-way clutch 32 eliminates the position fluctuation of the pressure chamber 26 due to the reverse rotation force, and the stepping motor M accordingly requires no supply of electric power except for in a case where the print gap is adjusted.

The sensor flag 33 is provided on the drive axis 31. The sensor flag 33 is used to detect a reference phase of the rotation phase of the cam 29. The reference phase is set to, for example, a rotation phase at which the pressurizing portion 28 reaches the lowest point or the highest point. In the at least one embodiment, the rotation phase of the cam 29 at which the pressurizing portion 28 reaches the lowest point is the reference phase as exemplified in FIG. 7A.

FIG. 10 is a configuration diagram of a controller for controlling operation of those print gap adjustment mechanisms 50. The controller includes a central processing unit (CPU) 601, a read-only memory (ROM) 602, a random access memory (RAM) 603, a non-volatile memory 604, and an operation portion 605. The CPU 601 controls operation of the print gap adjustment mechanisms 50 by executing a computer program stored in the ROM 602. Operation of the CPU 601 is controlled by instructions from a main control portion (not shown) which controls overall operation of the print module 2000. The RAM 603 provides a work area for execution of processing by the CPU 601.

The non-volatile memory 604 stores various types of information required to control operation of the print gap adjustment mechanisms 50. For example, information indicating rotation phases of the cams 29 that correspond to appropriate print gaps is stored in the non-volatile memory 604 prior to shipment, at the time when the print gap adjustment mechanisms 50 are attached during assembly of the print belt unit 2200. The rotation phases indicated by the information stored in the non-volatile memory 604 correspond to the number of rotations of each stepping motor M from the reference phase detected by the sensor flag 33. The non-volatile memory 604 can store, for each motor, information on a plurality of rotation phases suited to thicknesses of sheets.

For example, the information on rotation phases stored in the non-volatile memory 604 indicates rotation phases of the cams 29 that are measured in a case where print gaps of respective colors are kept to a predetermined distance, with a sheet actually stuck by suction to the conveyor belt 24. This measurement of rotation phases is performed for each of a plurality of types of sheets (plain paper, heavy paper, thin paper, and the like), and information on each set of rotation phases is stored in the non-volatile memory 604. For example, the non-volatile memory 604 stores, for each motor, information that associates a thickness depending on the type of sheet with a rotation phase. The predetermined distance is, for example, 1.38 mm.

As a result, even in a case where a tolerance varies among the four cams 29, print gaps in the recording heads 2301 of the respective colors can be kept to the predetermined distance irrespective of the paper type. Consequently, the recording heads 2301 of the respective colors each take a predetermined time as a time from ejection of ink from the nozzle surface to arrival of the ink at the sheet. That is, a phenomenon in which relative positions of images of the recording heads 2301 of the respective colors relative to the sheet vary depending on the type of the sheet used can be reduced. In other words, image defects such as color misregistration that may occur in adjustment of the distance between the sheet surface on which an image is to be formed and the nozzle surface of each of the recording heads 2301 can be reduced. In short, degradation of image quality can be reduced.

FIG. 11 is an exemplary table of the information on rotation phases stored in the non-volatile memory 604. This information expresses each sheet type in basis weight. A rotation phase associated with a basis weight of a sheet is expressed by the number of rotations of the stepping motor M having a correlation with the rotation phase of one of the cams 29 that is of interest. The number of rotations of the stepping motor M is expressed by the number of pulses of a pulse signal that is a control signal used by the CPU 601 to control the stepping motor M. The information indicating the type of a sheet may be the thickness of the sheet.

The CPU 601 refers to the information stored in the non-volatile memory 604 to check the number of pulses associated with the basis weight. With timing of detection of the reference phase by the sensor flag 33 as a trigger, the CPU 601 causes the stepping motor M to rotate a number of times that is the number of rotations corresponding to the checked number of pulses. This causes the cam 29 to rotate by the number of phases corresponding to the number of pulses, and the rotation phase of the cam 29 is consequently controlled with high precision. The position of the pressure chamber 26 moves so as to close or increase the distance from the recording portion 2300, depending on the rotation phases of the cams 29, and the print gap is thus determined. The print gap is precisely controlled by controlling the rotation phases of the cams 29 with high precision.

The operation portion 605 is a user interface including an input interface and an output interface. The input interface includes various key buttons, a touch panel, and the like. The output interface includes a display, a speaker, and the like.

### <Printing Operation>

The image forming system 100 includes a storage apparatus for storing thicknesses of sheets usable in a print job. The image forming system 100 acquires information on the thickness of a sheet instructed to be used in a print job from this storage apparatus. The information on the thickness of the sheet is acquired through input of a paper type of the sheet by a user from the operation portion 605, or acquired from a result of detection by a media sensor (not shown) provided on the conveying path of the sheet.

In the case in which the paper type of the sheet is input from the operation portion 605, the image forming system 100 holds, in advance, a table indicating a correlation between a paper type and information on the thickness of a sheet, and acquires the information on the thickness of the sheet by referring to this table. In the case of using the media sensor, the media sensor is provided on a conveying path of a sheet inside the sheet feeding module 1000, or a conveying path for conveying a sheet to the recording portion 2300 of the print module 2000. The media sensor is, for example, an ultrasonic sensor, and emits an ultrasonic wave to the sheet and receives the ultrasonic wave transmitted through the sheet. The image forming system 100 holds, in advance, a table indicating a correlation between an amplitude of an ultrasonic wave received by the media sensor and the information on the thickness of a sheet, and acquires the information on the thickness of the sheet by referring to this table.

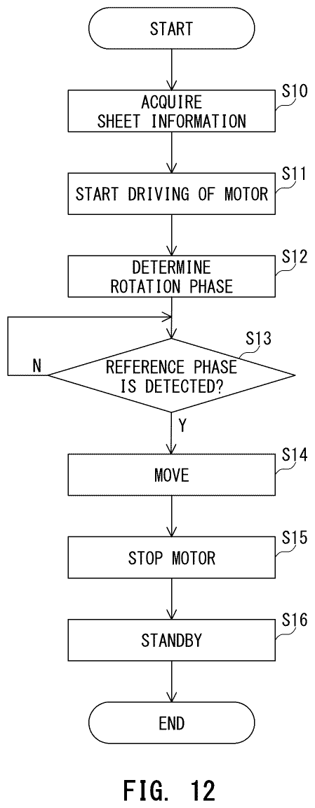

FIG. 12 is a flow chart for illustrating print gap adjustment processing in the at least one embodiment. The processing of this flow chart is executed by the CPU 601 in a case where, for example, an instruction to start a print job is input.

The CPU 601 acquires, as sheet information, the information on the thickness of the sheet (Step S10). Here, the CPU 601 acquires the basis weight of the sheet as the information on the thickness of the sheet. The CPU 601 excites each stepping motor M to start driving each stepping motor M (Step S11). The CPU 601 refers to the information stored in the non-volatile memory 604 to check, for each motor, the number of pulses associated with the acquired information on the thickness of the sheet (the basis weight) (Step S12). The rotation phase of each of the cams 29 is thus determined.

The CPU 601 stands by until the sensor flag 33 detects the reference phase (Step S13: N). In a case where detection of the reference phase by the sensor flag 33 occurs (Step S13: Y), the CPU 601 drives each stepping motor M by an amount corresponding to the number of pulses checked in the processing step of Step S12, to thereby move the pressure chamber 26 (Step S14). A print gap appropriate for the thickness of the sheet is thus secured for each color. After the print gap is controlled so as to be an appropriate gap, the one-way clutch 32 suppresses rotation of each of the cams 29, and the CPU 601 accordingly stops excitation of each stepping motor M to stop driving the stepping motor M (Step S15).

A change in print gap changes the tensile force applied to the conveyor belt 24, and the change in tensile force causes a rotation speed and a posture of the conveyor belt 24 in some cases. In such a case, the print belt unit 2200 controls the position of the at least one of the suspension rollers that functions as a tension roller, to thereby apply a predetermined tensile force to the conveyor belt 24 so that the conveyor belt 24 settles. The CPU 601 stands by for a predetermined time for settlement of the conveyor belt 24 by print gap adjustment (Step S16). The predetermined time for which the CPU 601 stands by is, for example, 30 seconds. At the end of the stand-by time, the print gap adjustment processing is ended. The image forming system 100 turns the conveyor belt 24 for a length of time required for the conveyor belt 24 to settle, and then starts the print job.

In the at least one embodiment, the print gap adjustment mechanisms 50 move the positions of the pressure chamber 26 and the platen 25 (the position of the sheet) to positions suited to the thickness of the sheet. The platen 25 comes into contact with the conveyor belt 24 from an inner circumferential surface side to move the conveyor belt 24 in relation to the recording heads 2301 in a manner depending on the thickness of the sheet. Accordingly, position control higher in precision than in a configuration of the related art in which the entire print belt unit frame 2201 is moved can be achieved.

As a result, the distance between the nozzle surface from which ink is ejected and the printing surface of the sheet is kept to a predetermined distance irrespective of the paper type, and a surface area of the ink adhered to the sheet accordingly has a predetermined magnitude. Images printed on sheets accordingly have a constant size per dot. That is, a phenomenon in which a resolution of an image output by the image forming apparatus varies depending on the type of the sheet used can be reduced.

In addition, because the distance between the nozzle surface from which ink is ejected and the printing surface of the sheet is kept to the predetermined distance irrespective of the paper type, ink ejected from the nozzle surface takes a predetermined time to reach the sheet. As a result, a phenomenon in which the relative position of an image relative to the sheet varies depending on the type of the sheet used can be reduced.

Further, with the positions of the pressure chamber 26 and the platen 25 (the position of the sheet) adjusted by four motors, even in a case where the tolerance varies among the four cams, print gaps of the respective colors can be kept to the predetermined distance irrespective of the paper type. As a result, a phenomenon in which relative positions of images of the respective colors relative to the sheet vary depending on the type of the sheet used can be reduced. That is, image defects such as color misregistration that may occur in adjustment of the distance between the sheet surface on which an image is to be formed and the nozzle surface of each of the recording heads can be reduced. In short, degradation of image quality can be reduced. In this manner, in the at least one embodiment, a phenomenon in which the relative position of an image relative to the sheet varies depending on the type of the sheet used can be reduced.

In the at least one embodiment, the pressure chamber 26 weighs, for example, approximately 10 kg. The recording heads 2301 each weigh, for example, approximately 8 kg. Accordingly, compared to a configuration that moves a header holder unit to which a plurality of recording heads 2301 are fixed in relation to a sheet conveying surface, the configuration that moves the pressure chamber 26 in relation to the recording heads 2301 requires only a small drive force, and hence can be achieved as a simple configuration. In addition, because the pressure chamber 26 is lighter in weight than the entirety of the print belt unit frame 2201, only a small force is required as the drive force of the stepping motor M, and the stepping motor M itself can accordingly be reduced in size. The small size of the stepping motor M enables the image forming system 100 (the print module 2000) to be smaller in size than that in the related art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-077469, filed May 9, 2023, which is hereby incorporated by reference herein in its entirety.

What is claimed is:

1. An image forming apparatus, comprising:
a belt configured to convey a sheet;
a plurality of rollers over which the belt is stretched, the plurality of rollers including a drive roller to which a drive force is to be applied;
a support portion configured to support at least one of the plurality of rollers in a manner that allows the at least one of the plurality of rollers to rotate;
an ejection portion configured to eject ink onto the sheet conveyed by the belt;
a movable member placed in a movable manner on an inner circumferential surface side of the belt in order to adjust a distance between the ejection portion and an outer circumferential surface of the belt at a position opposed to the ejection portion;
a cam configured to displace a position of the movable member in relation to the plurality of rollers; and
a control portion configured to rotate, in order to adjust the distance, the cam by an amount depending on a basis weight of the sheet.

2. The image forming apparatus according to claim 1, further comprising a suction unit configured to stick the sheet by suction to the belt,
wherein the belt is configured to convey the sheet stuck by suction to the belt.

3. The image forming apparatus according to claim 1,
wherein the movable member further includes a suction unit for sticking the sheet by suction to the belt, and
wherein the belt is configured to convey the sheet stuck by suction to the belt.

4. The image forming apparatus according to claim 2,
wherein the suction unit includes a pressure chamber configured to generate a negative pressure therein,
wherein the pressure chamber has a hole that communicates with an outside, and
wherein the suction unit is configured to suction the sheet through the hole under a state in which a pressure inside the pressure chamber is a negative pressure.

5. The image forming apparatus according to claim 1, wherein the belt has an endless shape.

6. The image forming apparatus according to claim 1, further comprising a frame configured to support the plurality of rollers,
wherein the ejection portion is attached to the frame.

7. The image forming apparatus according to claim 1,
wherein the cam is configured to displace, in a case where the basis weight of the sheet conveyed by the belt is a first basis weight, the movable member so that a height of the movable member in relation to the plurality of rollers is a first height, and
wherein the cam is configured to displace, in a case where the basis weight of the sheet conveyed by the belt is a second basis weight lighter than the first basis weight, the movable member so that the height of the movable member in relation to the plurality of rollers is a second height higher than the first height.

8. The image forming apparatus according to claim 1,
wherein the control portion includes a memory in which relationship between the basis weight of the sheet and the position of the movable member in relation to the plurality of rollers is recorded, and
wherein the control portion is configured to control the position of the movable member in relation to the plurality of rollers based on information stored in the memory.

9. The image forming apparatus according to claim 1, wherein the cam is an eccentric cam.

10. The image forming apparatus according to claim 1, further comprising:
a drive axis for transmitting a drive force to the cam; and
a one-way clutch which is provided on the drive axis, and which is configured to restrict rotation of the cam to one direction.
